(19) United States
(12) Patent Application Publication
(10) Pub. No.: US 2014/0301481 A1
(43) Pub. Date: Oct. 9, 2014

(54) APPARATUSES AND METHODS FOR POOLING MULTIPLE CHANNELS INTO A MULTI-PROGRAM TRANSPORT STREAM

(71) Applicant: MAGNUM SEMICONDUCTOR, INC., Milpitas, CA (US)

(72) Inventor: Patel Novotny, Waterloo (CA)

(73) Assignee: Magnum Semiconductor, Inc., Milpitas, CA (US)

(21) Appl. No.: 13/856,995

(22) Filed: Apr. 4, 2013

(51) Int. Cl. H04N 19/88

(52) U.S. Cl. CPC H04N 19/00927
USPC 375/240.26

(57) ABSTRACT

Examples of apparatuses and methods for pooling multiple channels into a multiple program transport stream are described herein. An example apparatus may include a statistical multiplexing (statmux) system coupled to a communication link. The statmux system includes a virtual buffer verifier (VBV) shifter and a plurality of encoders. The VBV shifter is configured to receive respective encoded bitstreams of encoded coding units from the plurality of encoders and to provide a plurality of encoded coding units to a common data pool. The VBV shifter is further configured to remove an encoded coding unit of the plurality of encoded coding units from the common data pool to be combined with other encoded coding units of the plurality of encoded coding units for transmission on the communication link based on a target bitrate.

### TECHNICAL FIELD

Embodiments described relate to video encoding, and in particular to pooling multiple channels into a multi-program transport stream.

### BACKGROUND

In content distribution environments, communication links may be created with each communication link having a fixed bandwidth. The fixed bandwidth of a communication link is typically higher than the bandwidth needs of any single channel of media content provided from a content provider. Thus, content providers may pool encoded bitstreams of several channels together to maximize use of the bandwidth of the communication link. Modern block based video coding standards such as MPEG2, H.261, H.262, H.263 and H.264 take advantage of temporal and spatial redundancy of a channel to achieve efficient video compression, but produce variable bitrate (VBR) bitstreams. Thus, as complexity of source content of the channel changes, the bitrates of the encoded bitstreams may vary over time. A quantification of complexity is often specific to a video coding algorithm and an encoder used to encode the content. One issue with pooling encoded bitstreams of several channels is managing the variability of the bitrates of each encoded bitstream to efficiently use bandwidth of a constant bitrate communication link and maintain consistent video quality on each channel.

A conventional implementation of managing bandwidth of a pool of encoded bitstreams may use a statistical multiplexer (statmux) system. The statmux system may include several encoders, a controller, and a multiplexer. The inputs to the encoders may be content channels to be encoded for the purpose of content distribution. Encoded bitstreams are provided from the encoders to a multiplexer. The multiplexer may be configured to combine the encoded bitstreams into a multi-program transport stream (MPTS). On the receiving side, one or more encoded bitstreams are de-multiplexed from the MPTS using standard de-multiplexing techniques and decoded back into video. A statmux system may be beneficial in this scenario since it can pool multiple channels together in such a way that the final bitstream produces a continuous bitrate, which may be distributed over existing distribution networks.

A typical way of controlling the individual encoders in a statmux system is to divide time into time slots having fixed periods, and to divide the available bandwidth of the communication link for a time slot between the channels in a way that accounts for each channel's complexities. Each encoder is likely to be producing different bitrates at different times, and on average, if the complexity of the content on one channel increases, the complexity of another channel's content might be reduced in the same time. The encoders then encode content based on the assigned bitrates for a time slot without exceeding the given limits to avoid exceeding a bandwidth of the communication link for the time slot.

There may be potential complexities associated with the conventional statmux setup. One potential complexity may result from a delay between when an encoder encodes some portion of the content based on the assigned bitrate and when the encoded bitstream containing the encoded portion actually appears on the output of the encoder. The delay may be variable, depending on the complexity of the content and the assigned encoding bitrate. For example, the variable delay may be based on a method used to control the rate of the encoders. Many standard rate control algorithms in encoders use a Virtual Buffer Verifier (VBV) buffer model. The output from the VBV buffer may be a constant bit-rate, so as variable encoding bitrates rise and fall at an input to a VBV buffer based on complexity of the content, an amount of data in the VBV buffer may continuously rise and fall accordingly. The variable delay may also be a function of the amount of data present in the VBV buffer (e.g., more data in the VBV buffer increases delay).

Thus, in addition to assigning a bitrate, the controller must estimate when the encoded bitstream will be provided at an output without knowing the level of the respective VBV buffer. When an encoder is assigned a bitrate for a given time slot, the encoder must have the encoded data designated for the given time slot available at an output by a start of the time slot. Additionally, since each encoder is assigned a fixed bit budget for a fixed time period (e.g., the assigned bitrate), an encoder may have to adjust a video quality to fit the media content to be encoded into the fixed bit budget, which may arise based on errors in content complexity estimations for a channel. The adjustments made to meet the timing and encoding bitrate conditions may degrade the video and result in reduced video quality.

### BRIEF DESCRIPTION OF THE DRAWINGS

FIG. 1 is a block diagram of a content distribution system including a statmux system with a virtual buffer verifier (VBV) shifter according to an embodiment of the disclosure;

FIG. 2 is a block diagram of a content distribution system including a statmux system with a virtual buffer verifier (VBV) shifter according to an embodiment of the disclosure;

FIG. 3 is timing diagram of division of bandwidth of a communication link over time according to an embodiment of the disclosure;

FIG. 4 is a schematic illustration of a media delivery system according to an embodiment of the disclosure; and

FIG. 5 is a schematic illustration of a video distribution system that may make use of a media delivery system described herein.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

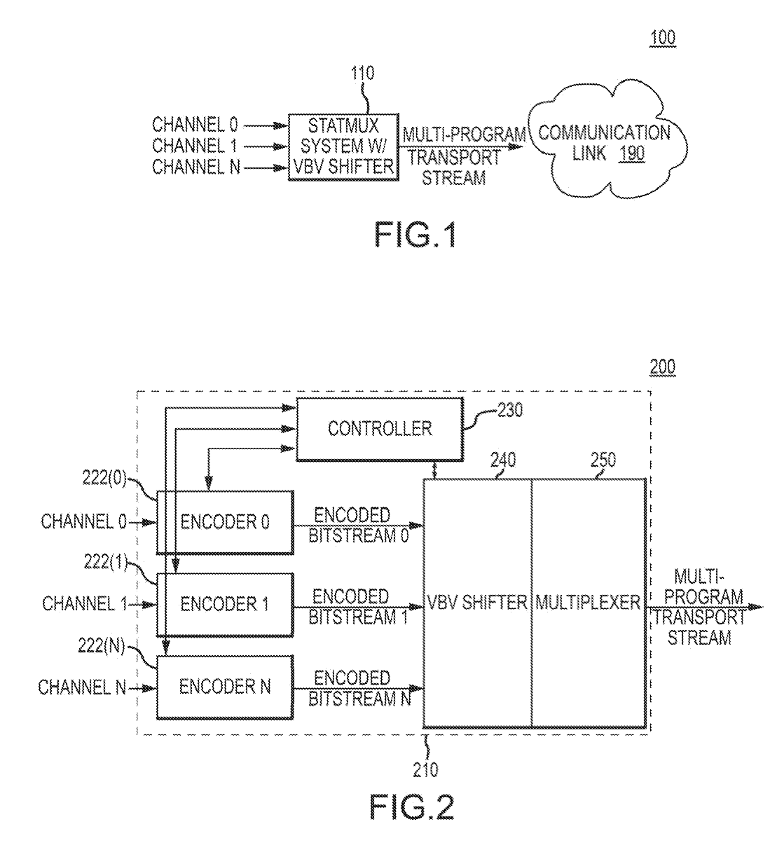

FIG. 1 is a block diagram of a content distribution system 100 including a statistical multiplexer (statmux) with a virtual buffer verifier (VBV) shifter 110 according to an embodiment of the disclosure. The content distribution system 100 may be implemented in hardware, software, firmware, or combinations thereof, and may include control logic, logic gates, processors, memory, and/or any combination or sub-combination of the same, and may be configured to encode and/or compress one or more channels 0-N to provide one or more encoded bitstreams using one or more encoding techniques, and to pool the one or more encoded bitstreams into a multi-program transport stream (MPTS) to provide over a communication link 190.

The statmux with the VBV shifter 110 may include one or more encoders, a controller, a multiplexer and/or a VBV shifter. As explained above, the statmux with the VBV shifter 110 may be configured to receive frames via the respective channels 0-N, and to generate encoded bitstreams using one or more encoding techniques. The encoded bitstreams may be variable bitrate bitstreams, with variance based on, for example, a complexity of the frames of content of the respective channels 0-N. Examples of variables that may affect complexity may include spatial complexity of a frame of content of a channel (e.g., texture) and temporal complexity of a frame of content of a channel (e.g., amount of motion). The statmux with the VBV shifter 110 may be configured to provide the MPTS to the communication link 190. The communication link 190 may have a fixed bandwidth.

In operation, transmission over the communication link 190 may be controlled based on time slots, wherein the channels 0-N are assigned a bitrate for a shared time slot. For example, prior to encoding frames of each of the channels 0-N, the statmux with the VBV shifter 110 may be configured to compare complexities of the respective frames of each of the channels 0-N, and to assign a bitrate to be used to encode the respective frames. For each of the channels 0-N, a quality parameter may be selected to encode the respective frames based on the assigned bitrate associated with the respective frames. The frames may also be associated with a decode timestamp (DTS), which is included with the encoded frame. The DTS indicates a time that may be relative to other frames received at the encoder, and may be used by a decoder to decode a frame. The respective frames of each of one or more channels are encoded into respective encoded frames based on the quality parameter. The encoding algorithms for each encoder may result in encoded frames having variable bitrates. The encoders may employ a Virtual Buffer Verifier (VBV) buffer model to control bitrate provided from each encoder. To support the VBV buffer model, the respective encoded frames are provided to respective VBV buffers. An encoded bitstream provided from each VBV buffer may be a constant bit-rate. Thus, a level of each of the VBV buffers may rise and fall as encoded bitrates of frames provided to the VBV buffers rise and fall as compared with the constant bitrate rate at the output of the VBV buffers. The respective encoded frames may be provided from the respective VBV buffers to a common data pool via the encoded bitstreams. In some embodiments, the respective encoded frames may be packetized into transport packets, with each packet being time stamped. The packets may be removed from the common data pool at a constant bit-rate, combined, and provided in the MPTS at an output of the statmux with the VBV shifter 110 over the communication link 190.

The VBV shifter may be configured to provide the packets for combination based on actual bitrates and timestamps. For example, each VBV buffer may be configured to provide the respective encoded frame at an output. Relative timing of provision of the respective encoded frames associated with a time slot may vary due to differences in data levels of respective VBV buffers. Additionally, an actual bitrate associated with a respective frame may vary from the assigned bitrate for a time slot. Based on relative timing differences between the respective encoded frames and based on the relative bitrate differences, the VBV shifter may be configured to promote and/or delay the transport stream packets including the respective encoded frames to an earlier or a later time slot in order to efficiently use the bandwidth of the communication link 190. The VBV shifter configured to manage combinations of encoded frames to the multiplexer encoded bitstream data may simplify the encoders and may result in more consistent video quality from the encoders.

FIG. 2 is a block diagram of a statistical multiplexer (statmux) system 200 including a statmux with a virtual buffer verifier (VBV) shifter 210 according to an embodiment of the disclosure. The statmux with the VBV shifter 210 may be implemented in hardware, software, firmware, or combinations thereof, and may include control logic, logic gates, processors, memory, and/or any combination or sub-combination of the same, and may be configured to encode and/or compress respective frames of the channels 0-N to provide one or more encoded bitstreams 0-N using one or more encoding techniques, and to combine the encoded bitstreams 0-N into a multi-program transport stream (MPTS) signal.

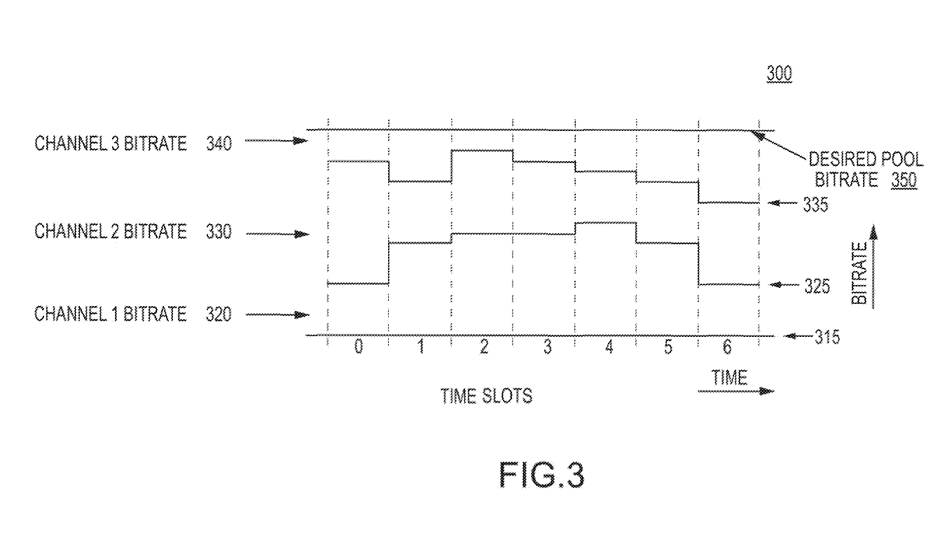

The statmux with the VBV shifter 210 may include a controller 230 configured to receive respective channel 0-N complexity information from one or more of the encoders 0-N 222(0-N). Examples of complexity information of a channel may include spatial complexity (e.g., texture) of a frame of a channel and temporal complexity (e.g., motion complexity) of a frame of a channel. The controller 230 may be configured to divide time associated with a communication link having a fixed bandwidth into time slots. For a given time slot the controller 230 may be configured to assign respective bitrates to the encoders 0-N 222(0-N) based on analysis of the complexity information. The controller 230 may be configured to provide the given time slot information (e.g., a start time, an end time, and/or a length) and the respective assigned bitrates assigned to the encoders 0-N 222(0-N). An aggregate of the respective assigned bitrates to the encoders 0-N 222(0-N) may be equal to a target bitrate. In some embodiments, the target bitrate may be equal to a fixed bandwidth of the communication link. FIG. 3 illustrates an exemplary embodiment of division of bandwidth of a communication link over time. In some embodiments, the controller 230 is configured to assign the respective bitrates to the encoders 0-N 222(0-N) based on the respective complexity information in order to maintain encoding quality without exceeding the target bitrate.

The encoders 0-N 222(0-N) may be configured to receive respective coding units via the respective channels 0-N and to provide respective encoded coding units via the encoded bitstreams 0-N at an output. Examples of coding units may include frames, sub-frames, regions, macroblocks, etc. In the interest of clarity, operation of the encoders 0-N 222(0-N) and the virtual buffer verifier (VBV) shifter 210 will discussed in terms of frames as coding units. The encoders 0-N 222(0-N) may include respective entropy encoders, such as a variable-length coding encoder (e.g., Huffman encoder, context-adaptive variable length coding (CAVLC) encoder, or context-adaptive binary arithmetic coding (CABAC) encoder), and/or may be configured to encode the frames, for instance, at a macroblock level. Each macroblock may be encoded in intra-coded mode, inter-coded mode, bidirectionally, or in any combination or subcombination of the same. As an example, the encoders 0-N 222(0-N) may receive and encode respective frames via the respective channels 0-N. The respective channels 0-N may be encoded in accordance with one or more encoding algorithms or standards, such as MPEG-2, MPEG-4, H.263, H.264, and/or HEVC. The encoding algorithms or standards for each encoder 0-N 222(0-N) may result encoded frames having variable bitrates. The encoders 0-N 222(0-N) may employ a Virtual Buffer Verifier (VBV) buffer model to control bitrate of the respective encoded bitstreams 0-N provided from each encoder 0-N 222(0-N). To support the VBV buffer model, the respective encoded frames are provided to respective VBV buffers of each encoder 0-N 222(0-N), and the respective encoded bitstream 0-N provided from each of the respective VBV buffers has a constant bitrate. In some embodiments, the encoders 0-N 222(0-N) may be configured to record a decode timestamp (DTS) of a frame, and to provide the DTS with the encoded frame in the respective encoded bitstreams 0-N. The DTS may provide relative timing of the frames received via the respective channel 0-N.

The statmux with the VBV shifter 210 may further include a VBV shifter 240 coupled to a multiplexer 250. The VBV shifter 240 may be configured to receive the encoded bitstreams 0-N from the encoder 1-N 222(0-N). In some embodiments, the VBV shifter 240 may be configured to packetize frames and/or subframes of data received in the encoded bitstreams 0-N into transport stream packets and store the transport stream packets into a common data pool. The VBV shifter 240 may also be configured to receive the target bitrate and/or time slot information (e.g., start time, end time, and/or length) from the controller 230. Based on the target bitrate and based on a delay of the packetized data (e.g., determined based on the DTSs) of the encoded bitstreams 0-N, the VBV shifter 240 may be configured to provide transport stream packets including the encoded frames from the common data pool to the multiplexer 250. The multiplexer 250 may be configured to combine the transport stream packets from the VBV shifter 240 into the MPTS, and to provide the MPTS to the communication link.

In an example operation, the controller 230 may be configured to manage transmission of encoded bitstreams 0-N having variable bitrates via the MPTS over a communication link. The communication link may have a fixed bandwidth (e.g., a constant bitrate). The controller 230 may be configured to divide transmission time of the communication link into time slots that are shared by the encoders 0-N 222(0-N). For a shared time slot, the controller 230 may be configured to provide a respective assigned bitrate to each of the encoders 0-N 222(0-N) based on complexity information associated with respective frames of the respective channels 0-N. For example, each of the respective encoders 0-N 222(0-N) may be configured to receive respective frames via the corresponding channel 0-N. The encoders 0-N 222(0-N) may be configured to record a DTS associated with each received frame. Based on the received respective frames of the respective channels 0-N, the encoders 0-N 222(0-N) may be configured to provide respective complexity information to the controller 230 based on the respective frames of the one or more channels 0-N. The controller 230 may be configured to analyze and/or compare the complexity information received from the encoders 0-N 222(0-N). The controller 230 may also be configured to estimate a delay time between receipt of a respective frame and output of the encoded frame in the corresponding encoded bitstreams 0-N. For a shared time slot, the controller 230 may be configured to assign a respective bitrate to each of the encoders 0-N 222(0-N) based on the complexity information, the estimated delays, and/or the target bitrate. In some embodiments, the aggregated assigned bitrates provided by the controller 230 to the encoders 0-N 222(0-N) may be equal to the target bitrate. The controller 230 may be further configured to provide timing information corresponding to the shared time slot (e.g., start time, end time, and/or length) to the encoders 0-N 222(0-N) and/or the VBV shifter 240.

Based on the respective assigned bitrates received from the controller 230, each of the encoders 0-N 222(0-N) may be configured to select a value of a quantization parameter (QP) that most closely equals the respective assigned bitrate, in some embodiments, without exceeding the respective assigned bitrate. The encoders 0-N 222(0-N) may be configured to encode the respective frames of the respective channels 0-N to generate the encoded frames in the respective encoded bitstream 0-N based on the selected QP. The respective encoded bitstream 0-N may further include the respective DTS associated with an encoded frame that is recorded at receipt by the respective encoder 0-N 222(0-N). Each encoded bitstream 0-N may be provided to the respective VBV buffer of the respective encoder, and the respective VBV may provide the corresponding encoded bitstream 0-N to the VBV shifter 240 at a constant bitrate.

The VBV shifter 240 may be configured to packetize the one or more encoded frames of the respective bitstreams 0-N into the transport stream packets, with each packet being time stamped. The VBV shifter 240 may be further configured to place the transport stream packets into a common data pool, and to provide the transport stream packets from the common data pool to the multiplexer 250 at a constant rate based on the target bitrate. In some embodiments, the VBV shifter 240 may provide the transport stream packets to the multiplexer 250 at a rate that consumes the bandwidth of the communication link.

A quality of each of the encoded bitstreams 0-N may be based on the assigned bitrates provided from the controller 230. As explained above, the encoders 0-N 222(0-N) may be configured to select a respective QP. The respective QPs may be used to adjust and/or optimize rate-distortion in order for the respective encoders 0-N 222(0-N) to provide encoded bitstreams 0-N that efficiently use the respective assigned bitrate. The respective QP may be determined based on the respective assigned bitrate from the controller 230 and based on the frames of the respective channel 1-N. For example, the encoders 0-N 222(0-N) may select a QP value that is estimated to result in encoded frames having a bitrate that equals without exceeding the assigned bitrate for a time slot. The estimate may be based on an estimated complexity of the frames of the respective channel 0-N. In some embodiments, the respective QP may be fixed for an entire time slot. In other embodiments, the respective QP may be adjusted for each macroblock or a frame of a channel 0-N based on data encoded by the respective encoder 0-N 222(0-N).

Each frame of a respective channel 0-N may vary in complexity, and, thus, an actual bit cost to encode each frame may vary from frame to frame. Because a respective encoder 0-N 222(0-N) selects a respective QP based on an estimated bitrate associated with encoding a respective frame or group of frames using the respective QP, an actual bitrate to encode the frame or group of frames using the selected QP may vary from the estimate. In some embodiments, the encoders 0-N 222(0-N) may allow differences between the assigned bitrate and the actual bitrates for encoding a frame.

Further, due to continuously variable encoded frame bitrates, the VBV buffer may receive the encoded frames having a variable bitrate. Because each VBV buffer is receiving encoded frames having variable bitrates, and providing the respective encoded bitstreams 0-N to the VBV shifter 240 at a constant bitrate, a data level in each VBV buffer may be continuously changing. Thus, a delay between receipt of a frame at a respective encoder 0-N 222(0-N) and provision of the encoded frame in the respective encoded bitstream 0-N may be dependent on the data level of the respective VBV buffer (e.g., delay increases as data level in a VBV increases). Because the controller 230 estimates a time slot for a frame, the timing of output of a code frame may vary from the estimate of the controller 230.

The VBV shifter 240 may be configured to manage the variance from the assigned bitrate for a respective frame and the variance in timing of output of the encoded frame in the respective encoded bitstream 0-N. As explained above, the VBV shifter 240 may be configured to provide the transport stream packets from the common data pool to the multiplexer 250 at a constant rate based on with the target bitrate. If some transport stream packets vary in actual bitrates and/or timing from the assigned bitrate or designated timing, the VBV shifter 240 may be configured to promote or delay removal of transport stream packets from the common data pool for combination at the multiplexer 250 to earlier or later time slots.

For example, for a shared time slot, if a current bitrate of the transport stream packets corresponding to the shared time slot in the common data pool is less than the target bitrate, transport stream packets corresponding to later time slots may be provided to the multiplexer at the shared time slot in order to equal the target bitrate. Sending transport stream packets designated for an earlier time slot may shift all remaining transport stream packets in the common data pool forward in time. Additionally, for a shared time slot, if a current bitrate of the transport stream packets corresponding to the shared time slot in the common data pool exceeds the target bitrate, one or more of the transport stream packets designated for the shared time slot may be delayed to a later time slot to prevent from exceeding the target bitrate, which may result in all remaining transport stream packets in the common data pool being shifted backwards in time (delayed).

In some embodiments, the channels 0-N and/or the encoders 0-N 222(0-N) may include respective encoding delay limits (e.g., minimum and/or maximum delay limits) from receipt to provision in the respective encoded bitstream 0-N at an output of the encoder 0-N 222(0-N). The encoding delay limits may be included to prevent interruption in consuming the encoded bitstreams downstream of the communications link at a receiver/decoder. For example, interruptions may occur when providing encoded bitstreams 0-N at a fast rate that empties the respective VBV buffer and causes a bubble between frames transmitted to the decoder. Further interruptions may occur when providing encoded bitstreams 0-N at a slow rate that causes gaps between frames such that a decoder/receive empties a buffer and has to wait for additional frames. In some embodiments, the delay limits may be different among the encoders 0-N 222(0-N). The VBV shifter 240 may be configured to obey the respective delay limits. For example, if it is determined that providing a transport stream packet associated with a respective channel (0-N) in an earlier time slot would be less than a minimum delay limit of the respective channel (0-N), then the transport stream packet and/or future transport stream packets of the respective channel (0-N) may be held back from being included in earlier time slots. Further, if delaying a transport stream packet associated with a respective channel 0-N to a later time slot would exceed the maximum delay limit of the respective channel 0-N, then the transport stream packet and/or future transport stream packets of the respective channel (0-N) may be excluded from being held back for later time slots. The data delay may be calculated based on the DTS and an expected transmission time.

The above example operation is provided for illustrative purposes, and is not intended to limit the disclosure. As explained above, while the description of operation of the statmux with the VBV shifter 210 is based on encoding of frames, it will be appreciated that operation of the statmux system 200 may be based on encoding of coding units, such as macroblocks, and/or other sub-coding units, such as portions of a frame, and the encoded coding units or encoded sub-coding units are provided to the VBV shifter 240 via the respective encoded bitstreams 0-N. It will be appreciated that, while FIG. 2 depicts three encoders, a statmux with the VBV shifter 210 may be configured to include 1, 2, or more than three encoders. The encoders 0-N 222(0-N) may have different architecture and/or may encode the frames of the respective channels 0-N using different encoding algorithms or standards, and may operate at different rates. It will be appreciated that encoding of channels may include other dependencies beyond bitrates and timing. The statmux with the VBV shifter 210 having the VBV shifter 240 may simplify operation of the encoders 0-N 222(0-N) as compared with conventional statistical multiplexing systems that require bitrates and timing from the encoders to be strictly controlled.

FIG. 3 is an exemplary timing diagram of division of bandwidth of a communication link over time. In the exemplary timing diagram, the horizontal axis represents time and the vertical axis represents a bitrate. The desired pool bitrate 350 may correspond to a bandwidth of a communication link. The vertical dotted lines represent divisions of time into time slots 0-6. The space between the desired pool bitrate 350 line and the barrier line 335 may represent an assigned bitrate for channel 3 340 by a controller, such as the controller 230 of FIG. 2. The space between the barrier line 335 line and the barrier line 325 may represent an assigned bitrate for channel 2 330. The space between the barrier line 325 and the barrier line 315 may represent an assigned bitrate for channel 1 320. As indicated in the timing diagram 300, the respective assigned bitrates for channels 1-3 320, 330, and 340 may vary between the time slots 0-6. However, the aggregate of the assigned bitrates for channels 1-3 320, 330, and 340 may equal the desired pool rate 350. The assigned bitrates for channels 1-3 320, 330, and 340 may correspond to respective encoders, such as the encoders 0-N 222(0-N) of FIG. 2.

It will be appreciated that, while the exemplary timing diagram 300 depicts time slots of equal length, time slots may vary in length over time. It will be further appreciated that bitrates for a particular time slot may be divided among two channels or more than three channels. While the exemplary timing diagram depicts 7 times slots, the transmission timing of a communication link may continue indefinitely. It will be appreciated that the application of bitrates among the encoders 1-3 320, 330, and 340 is for purposes of illustration, and that any allocation pattern within the desired pool bitrate 350 may be realized.

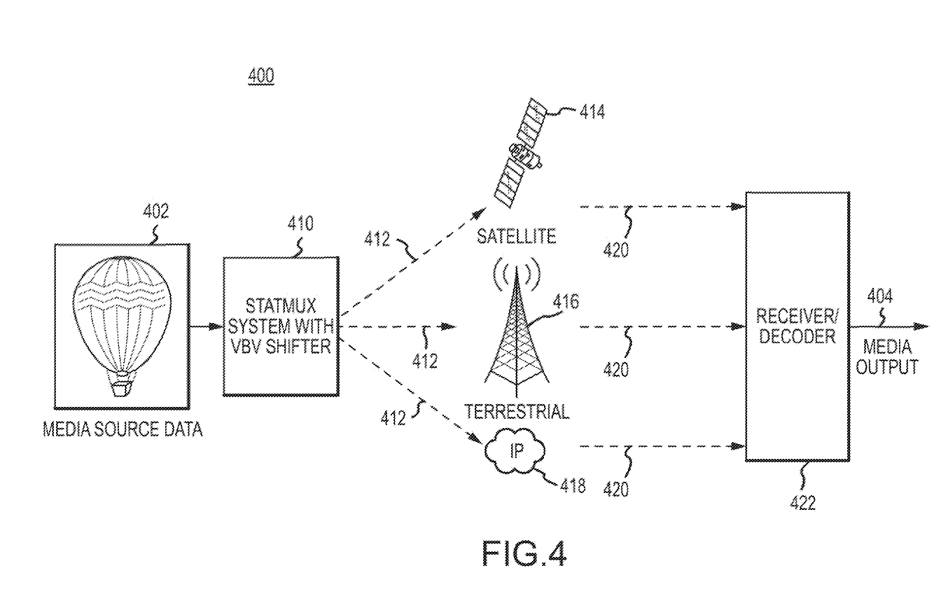

FIG. 4 is a schematic illustration of a media delivery system 400 in accordance with embodiments. The media delivery system 400 may provide a mechanism for delivering a media source 402 to one or more of a variety of media output(s) 404. Although only one media source 402 and media output 404 are illustrated in FIG. 4, it is to be understood that any number may be used, and examples may be used to broadcast and/or otherwise deliver media content to any number of media outputs.

The media source data 402 may be any source of media content, including but not limited to, video, audio, data, or combinations thereof. The media source data 402 may be, for example, audio and/or video data that may be captured using a camera, microphone, and/or other capturing devices, or may be generated or provided by a processing device. Media source data 402 may be analog or digital. When the media source data 402 is analog data, the media source data 402 may be converted to digital data using, for example, an analog-to-digital converter (ADC). The media source data 402 may represent several channels of media source data. Typically, to transmit each channel of the media source data 402, some type of compression and/or encryption may be desirable, with the compressed/encrypted channels being distributed over a common link. Accordingly, a statistical multiplexer with VBV shifter 410 may be provided that may encode each channel of the media source data 402 using any encoding method in the art, known now or in the future, including encoding methods in accordance with video standards such as, but not limited to, MPEG-2, MPEG-4, H.264, HEVC, or combinations of these or other encoding standards.

The statistical multiplexer with VBV shifter 410 may be further configured to combine encoded data of each channel of the media source data 402 based on a bandwidth of a communication link and to provide the combined encoded data 412 over a communications link. Examples of communications links may include a satellite 414, an antenna 416, and/or a network 418. The statistical multiplexer with VBV shifter 410 may be implemented using any statistical multiplexer with VBV shifter described herein, including the statistical multiplexer with VBV shifter statmux with the VBV shifter 110 of FIG. 1 and/or the statistical multiplexer with VBV shifter statmux with the VBV shifter 210 of FIG. 2. The network 418 may be wired or wireless, and further may communicate using electrical and/or optical transmission. The antenna 416 may be a terrestrial antenna, and may, for example, receive and transmit conventional AM and FM signals, satellite signals, or other signals known in the art. The communications communication link may broadcast the combined encoded data 412, and in some examples may alter the combined encoded data 412 and broadcast the altered combined encoded data 412 (e.g., by re-encoding, adding to, or subtracting from the combined encoded data 402). The combined encoded data 420 provided from the communications communication link may be received by a receiver 422 that may include or be coupled to a decoder. The decoder may decode the combined encoded data 420 to provide one or more media outputs, with the media output 404 shown in FIG. 4.

The receiver 422 may be included in or in communication with any number of devices, including but not limited to a modem, router, server, set-top box, laptop, desktop, computer, tablet, mobile phone, etc.

The media delivery system 400 of FIG. 4 and/or the statistical multiplexer with VBV shifter 410 may be utilized in a variety of segments of a content distribution industry.

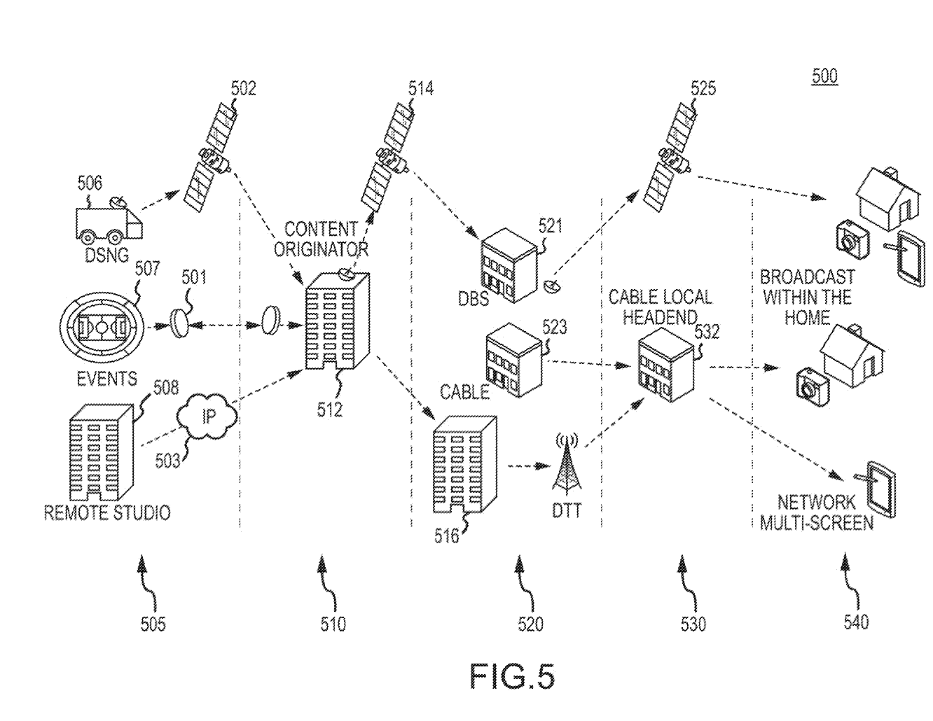

FIG. 5 is a schematic illustration of a video distribution system that 500 may make use of encoders described herein. The video distribution system 500 includes video contributors 505. The video contributors 505 may include, but are not limited to, digital satellite news gathering systems 506, event broadcasts 507, and remote studios 508. Each or any of these video contributors 505 may utilize statistical multiplexers with VBV shifters described herein, such as the statistical multiplexer with VBV shifter 410 of FIG. 4, to encode and combine multiple channels of media source data and provide combined channel encoded data to a communications link. The digital satellite news gathering system 506 may provide combined channel encoded data to a satellite 502. The event broadcast 507 may provide combined channel encoded data to an antenna 501. The remote studio 508 may provide combined channel encoded data over a network 503.

A production segment 510 may include a content originator 512. The content originator 512 may receive combined channel encoded data from any or combinations of the video contributors 505. The content originator 512 may make the received content available, and may edit, combine, and/or manipulate any of the received content to make the content available. The content originator 512 may utilize statistical multiplexers with VBV shifters described herein, such as the statistical multiplexer with VBV shifter 410 of FIG. 4, to provide combined channel encoded data to the satellite 514 (or another communications link). The content originator 512 may provide combined channel encoded data to a digital terrestrial television system 516 over a network or other communication link. In some examples, the content originator 512 may utilize a decoder to decode the content received from the contributor(s) 505. The content originator 512 may then re-encode and combine data; potentially utilizing statistical multiplexers with VBV shifters described herein, such as the statistical multiplexer with VBV shifter 410 of FIG. 4, and provide the combined channel encoded data to the satellite 514. In other examples, the content originator 512 may not decode the received data, and may utilize a transcoder (which may include of an encoder of the statistical multiplexer with VBV shifter 410 of FIG. 4) to change an encoding format of the received data.

A primary distribution segment 520 may include a digital broadcast system 521, the digital terrestrial television system 516, and/or a cable system 523. The digital broadcasting system 521 may include a receiver, such as the receiver 422 described with reference to FIG. 4, to receive combined channel encoded data from the satellite 514. The digital terrestrial television system 516 may include a receiver, such as the receiver 422 described with reference to FIG. 4, to receive combined channel encoded data from the content originator 512. The cable system 523 may host its own content which may or may not have been received from the production segment 510 and/or the contributor segment 505. For example, the cable system 523 may provide its own media source data 402 as that which was described with reference to FIG. 4.

The digital broadcast system 521 may include an encoder, such as the encoder with staggered-field intra-refresh 410 described with reference to FIG. 4, to provide encoded data to the satellite 525. The cable system 523 may include a statistical multiplexer with VBV shifter, such as the statistical multiplexer with VBV shifter 410 described with reference to FIG. 4, to provide combined channel encoded data over a network or other communications communication link to a cable local headend 532. A secondary distribution segment 530 may include, for example, the satellite 525 and/or the cable local headend 532.

The cable local headend 532 may include a statistical multiplexer with VBV shifter, such as the statistical multiplexer with VBV shifter 410 as described with reference to FIG. 4, to provide combined channel encoded data to clients in a client segment 540 over a network or other communications link. The satellite 525 may broadcast signals to clients in the client segment 540. The client segment 540 may include any number of devices that may include receivers, such as the receiver 422 and associated decoder described with reference to FIG. 4, for decoding content, and ultimately, making content available to users. The client segment 540 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus, comprising:
a statistical multiplexing (statmux) system coupled to a communication link, the statmux system comprising a virtual buffer verifier (VBV) shifter and a plurality of encoders, the VBV shifter configured to receive respective encoded bitstreams of encoded coding units from the plurality of encoders, the VBV shifter configured to provide a plurality of encoded coding units received via the encoded bitstreams to a common data pool, the VBV shifter further configured to remove an encoded coding unit of the plurality of encoded coding units from the common data pool to be combined with other encoded coding units of the plurality of encoded coding units for transmission on the communication link based on a target bitrate.

2. The apparatus of claim 1, wherein an encoder of the plurality of encoders is coupled to a respective channel and configured to provide the respective encoded bitstream including one or more encoded coding units of the plurality of encoded coding units based on a corresponding one or more coding units received via the respective channel.

3. The apparatus of claim 2, wherein the statmux system further comprises a controller configured to assign a bitrate to an encoder of the plurality of encoders associated with the one or more coding units received via the respective channel.

4. The apparatus of claim 3, wherein the bitrate is assigned to the encoder based on complexity information associated with the one or more coding units.

5. The apparatus of claim 3, wherein the controller is further configured to assign the respective bitrates based on a time slot associated with the communication link.

6. The apparatus of claim 1, wherein the VBV shifter is further configured to packetize the encoded coding unit prior to placing the encoded coding unit in the common data pool.

7. The apparatus of claim 1, wherein, responsive to an aggregated bitrate of the encoded coding unit and the other encoded coding units to be combined for transmission being less the target bitrate, the VBV shifter is further configured remove an additional encoded coding unit of the plurality of encoded coding units to be combined with the encoded coding unit and the other encoded coding units.

8. The apparatus of claim 1, wherein, responsive to aggregate bitrates of the encoded coding unit and the other encoded coding units to be combined for transmission exceeding the target bitrate, VBV shifter is further configured delay removal of the encoded coding unit from the global data pool.

9. The apparatus of claim 1, wherein the statmux system further comprises a multiplexer configured to combine the encoded coding unit and the other encoded coding units into a multi-program transport stream.

10. The apparatus of claim 1, wherein the target bitrate is based on a bandwidth of the communication link.

11. The apparatus of claim 1, wherein the VBV shifter further configured to remove the encoded coding unit of the plurality of encoded coding units from the common data pool to be combined with other encoded coding units of the plurality of encoded coding units for transmission on the communication link is further based on a time stamp associated with the encoded coding unit.

12. A non-transitory computer-readable medium comprising instructions that, when executed by one or more processing units, cause the one or more processing units to:
pool a plurality of encoded coding units of a plurality of encoded bitstreams at a VBV shifter, and
remove an encoded coding unit of the plurality of encoded coding units from the VBV shifter to be combined with other encoded coding units of the plurality of encoded coding units for transmission over a communication link based on a target bitrate.

13. The non-transitory computer-readable medium of claim 11, wherein removal of the encoded coding unit from the VBV shifter to be combined with other encoded coding units for transmission over a communication link is further based on a time stamp associated with the encoded coding unit.

14. The non-transitory computer-readable medium of claim 13, further comprising instructions that, when executed by the one or more processing units, cause the one or more processing units to delay removal of the encoded coding unit responsive to the aggregate bitrates of the encoded coding unit and the other encoded coding units exceeding the target bitrate.

15. The non-transitory computer-readable medium of claim 14, further comprising instructions that, when executed by the one or more processing units, cause the one or more processing units to override the delay of removal of the encoded coding unit responsive to the delay exceeding a delay limit associated with the encoded coding unit, wherein exceeding the delay limit is determined based on the timestamp associated with the encoded coding unit.

16. The non-transitory computer-readable medium of claim 13, further comprising instructions that, when executed by the one or more processing units, cause the one or more processing units to remove an additional encoded coding unit of the plurality of encoded coding units from the VBV shifter to be combined for transmission over a communication link responsive to the aggregate bitrates of the encoded coding unit and the other encoded coding units being less than the target bitrate.

17. The non-transitory computer-readable medium of claim 13, wherein instructions that, when executed by one or more processing units, cause the one or more processing units to combine the encoded coding unit and the other encoded coding units into a multi-program transport stream.

18. A method, comprising:
packetizing encoded coding units received via a plurality of encoded bitstreams into a plurality of individual packets;
pooling the individual packets into a common data pool; and
combining one or more individual packets of the plurality of individual packets from the common data pool based on a target bitrate and a respective timestamp associated with each of the one or more individual packets.

19. The method of claim 18, wherein combining the one or more individual packets from the common data pool based on the target bitrate and the respective timestamp associated with each of the individual packets comprises:
determining a total bitrate the one or more individual packets; and
comparing the respective timestamp of each of the one or more individual packets with an expected transmit time to determine respective expected delays.

20. The method of claim 19, wherein combining the one or more individual packets from the common data pool based on the target bitrate and the respective timestamp associated with each of the individual packets further comprises delaying combination of an individual packet of the one or more individual packets based on the total bitrate of the one or more individual packets exceeding the target bitrate and the respective expected delay being less than a maximum delay limit.

21. The method of claim 19, wherein combining the one or more individual packets from the common data pool based on the target bitrate and the respective timestamp associated with each of the individual packets further comprises an additional individual packet of the plurality of packets with the one or more individual packets based on the total bitrate of the one or more individual packets being less than the target bitrate and a respective expected delay associated with the additional individual packet being greater than a minimum delay limit.

22. The method of claim 19, further comprising providing the combined one or more individual packets to a communication link.
